(19) United States
(12) Patent Application Publication
(10) Pub. No.: US 2006/0203791 A1
(43) Pub. Date: Sep. 14, 2006

(54) Method, mobile station, system, network entity and computer program product for discovery and selection of a home agent

(75) Inventors: Inmaculada Carrion-Rodrigo, San Diego, CA (US); Meghana Sahasrabudhe, Sunnyvale, CA (US); Vijay Devarapalli, Sunnyvale, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/372,580

(22) Filed: Mar. 10, 2006

Related U.S. Application Data
(60) Provisional application No. 60/660,317, filed on Mar. 10, 2005.

(51) Int. Cl. H04J 3/22; H04L 12/56; H04L 12/28; H04Q 7/24; H04J 3/16

(52) U.S. Cl. 370/338; 370/389; 370/465

(57) ABSTRACT

A method, mobile station, system, network entity and computer program product are provided for enabling a mobile station (MS) to select which home agent (HA) in a visited network the mobile station will use when accessing packet data services, such as CDMA2000 Packet Data Services. In particular, one or more local home agent addresses are transmitted to the mobile station in response to the generation and transmittal, by the mobile station, of a tunnel setup request. The one or more addresses transmitted may be based on an IP Service Identifier generated by the mobile station and included in the tunnel setup request (i.e., in response to the mobile station requesting a local home agent). Alternatively, the one or more addresses may be based on a Network Access Identifier associated with the mobile station, as well as an IP address associated with the tunnel termination endpoint that received the tunnel setup request (i.e., automatically upon a determination that the mobile station requires a local home agent—without requiring the mobile station to request one).

### CROSS-REFERENCE TO RELATED APPLICATIONS

This application claims the benefit of priority from U.S. provisional application No. 60/660,317 filed on Mar. 10, 2005 and entitled “Method and System for Discovery and Selection of a Home Agent,” the contents of which is hereby incorporated herein by reference in their entirety.

### FIELD OF THE INVENTION

Exemplary embodiments of the present invention relate to service provisioning, and more particularly to mechanisms by which a mobile station can discover and select a Home Agent in a visited network.

### BACKGROUND OF THE INVENTION

CDMA2000, also known as IMT-CDMA, is a code-division multiple access (CDMA) version of the IMT-2000 (International Mobile Telecommunications-2000) standard developed by the International Telecommunication Union (ITU). The CDMA2000 standard is third-generation (3G) mobile telecommunications technology. CDMA2000 can support mobile data communications at speeds ranging from 144 Kbps to 2 Mbps, and in 2000, was the first 3G technology to be commercially deployed as part of the ITU's IMT-2000 framework.

A new feature that will provide secure access to CDMA2000 Packet Data Services by a mobile station, such as a mobile phone, personal digital assistant (PDA), or mobile personal computer (PC), is currently being developed in CDMA2000 WLAN IW (Wireless Local Area Network Interworking) by 3GPP2 (3^{rd} Generation Partnership Project 2), a cooperation of standards organizations throughout the world for the development of 3G data capabilities. Packet Data Services are high layer services (e.g., Multimedia Domain) offered by the CDMA2000 operator.

In general, this feature is provided by setting up a tunnel between the mobile station (MS) and a PDIF (Packet Data Interworking Function), a new network element which provides access to the Packet Data Services by providing IP connectivity to the CDMA2000 operator's network and/or other external networks (e.g., Corporate Service Access). The PDIF implements end-to-end secure tunnel management procedures between itself and the MS, including the establishment and release of the tunnel, allocation of an IP address to the MS from the CDMA2000 operator's network, and encapsulation and de-capsulation of traffic to and from the MS. The PDIF also enforces the CDMA2000 operator's policies such as packet filtering and routing. Through the interface to a Home-Authentication, Authorization and Accounting (H-AAA) server, the PDIF supports user authentication and transfer of authorization policy information. The PDIF also collects and transmits pre-tunnel accounting information. FIG. 1 illustrates a WLAN IW Architecture wherein this new feature is implemented in a roaming scenario (i.e., where the PDIF is in a local or visited network). See, for example, U.S. application Ser. No. 11/193,113 (“the '113 application”) entitled System, Method and Apparatus for Selecting a Remote Tunnel Endpoint for Accessing Packet Data Services, filed Jul. 29, 2005, the contents of which are hereby incorporated herein by reference in their entirety, which provides further details regarding the illustrated implementation.

Under this new feature, however, it is not possible for the MS to discover and select a Home Agent (HA) in a visited network. In typical cases, the MS selects a HA from the home link for mobility services. However, in some instances, for example, when the MS is roaming and is far from its home network, it may be desirable for the MS to be able to use a HA from the local visited network, especially when the MS wants access to services that are available exclusively in the visited network when it is roaming. As known to those skilled in the art, a HA is a router that maintains information regarding the current location of the MS, such as identified in the care-of-address of the MS. The HA uses tunneling mechanisms to forward Internet traffic so that the IP address of the MS need not be changed each time that the MS connects from a different location. One or more HAs may be located in the home network and/or a visited network and available to the MS. While certain ones of the available HAs may be better suited for servicing a request by a MS, current mechanisms for HA discovery, for example DHCP (Dynamic Host Configuration Protocol) or DHAAD (Dynamic Home Agent Address Discovery mechanism) for MIP6 (Mobility for Internet Protocol version 6) and “access registration reply” for MIP4 (Mobility for Internet Protocol version 4), do not allow the MS to request a particular HA or to influence the HA allocation. Instead, the MS receives only one HA address, which is allocated to it by the H-AAA server.

A need therefore exists for a mechanism by which a mobile station can request and select a particular HA in a visited network when accessing packet data services, such as CDMA2000 Packet Data Services.

### BRIEF SUMMARY OF THE INVENTION

Generally described, embodiments of the present invention provide an improvement over the known prior art by, among other things, providing a means by which a MS can select the particular home agent (HA) in a visited network that the MS will use when accessing packet data services, such as CDMA2000 Packet Data Services. In particular, one or more local home agent addresses are transmitted to the mobile station in response to the generation and transmittal, by the mobile station, of a tunnel setup request. The one or more addresses transmitted may be based on an IP Service Identifier generated by the mobile station and included in the tunnel setup request (i.e., in response to the mobile station requesting a local home agent). Alternatively, the one or more addresses may be based on a Network Access Identifier associated with the mobile station, as well as an IP address associated with the tunnel termination endpoint (e.g., PDIF) that received the tunnel setup request (i.e., automatically upon a determination that the mobile station requires a local home agent—without requiring the mobile station to request one).

According to one aspect of the present invention, a method is provided for enabling a mobile station to select a home agent in a visited network to use when accessing one or more packet data services. In one exemplary embodiment, the method includes: (1) transmitting a tunnel setup request; (2) receiving, in response to the tunnel setup request, one or more local home agent addresses; and (3) selecting one of the local home agent addresses received for use when accessing the one or more packet data services.

In one exemplary embodiment, the method further includes building an IP Service Identifier comprising a combination of one or more of a preferred service, a network operator, a service provider, a location of the mobile station, and a location of the service provider. In this exemplary embodiment, transmitting the tunnel setup request comprises transmitting a request comprising the IP Service Identifier, such that the IP Service Identifier is capable of being used to generate the one or more local home agent addresses.

In one exemplary embodiment, transmitting a tunnel setup request comprises transmitting the request to a tunnel termination endpoint. In this exemplary embodiment, the one or more local home agent addresses may be generated based at least in part on a Network Access Identifier associated with the mobile station, and an IP address associated with the tunnel termination endpoint.

According to another aspect of the present invention a system is provided for enabling a mobile station to select a home agent in a visited network to use when accessing one or more packet data services. In one exemplary embodiment, the system includes: (1) a mobile station configured to generate and transmit a tunnel setup request; and (2) a tunnel termination endpoint in communication with the mobile station configured to receive the request. The tunnel termination endpoint may further be configured, in response to receiving the request, to transmit one or more local home agent addresses, such that the mobile station is capable of selecting one of the local home agent addresses for use when accessing the one or more packet data services.

In one exemplary embodiment, the mobile station is further configured to generate an IP Service Identifier comprising a combination of one or more of a preferred service, a network operator, a service provider, a location of the mobile station, and a location of the service provider, and to include the IP Service Identifier in the tunnel setup request. The system of this exemplary embodiment may further include a memory accessible by the tunnel termination endpoint that includes a plurality of local home agent addresses, wherein the tunnel termination endpoint is further configured to access the memory and to select a respective one or more local home agent addresses to transmit to the mobile station based at least in part on the IP Service Identifier. Alternatively, the system of this exemplary embodiment may further include an Authentication, Authorization and Accounting (AAA) server, wherein the tunnel termination endpoint may be further configured to generate and transmit a service authorization request including the IP Service Identifier to the AAA server. The AAA server, in turn, may be configured to receive the service authorization request, to generate, based at least in part on the IP Service Identifier, the one or more local home agent addresses, and to transmit the addresses to the tunnel termination endpoint for transmitting to the mobile station.

In one exemplary embodiment, the system further includes a Home Authentication, Authorization and Accounting (H-AAA) server in communication with the tunnel termination endpoint, wherein the tunnel termination endpoint is further configured to request the one or more local home agent addresses from the H-AAA, and wherein the H-AAA is configured to generate and transmit the local home agent addresses to the tunnel termination endpoint for transmitting to the mobile station.

In another exemplary embodiment, the one or more local home agent addresses transmitted to the mobile station are automatically generated based on a Network Access Identifier associated with the mobile station and an IP address associated with the tunnel termination endpoint.

According to yet another aspect of the invention, a network entity is provided that is capable of enabling a mobile station to select from one or more home agents in a visited network to use when accessing one or more packet data services. The network entity may comprise a processor and a memory in communication with the processor and storing an application executable by the processor. In one exemplary embodiment, the application is capable, upon execution, of: (1) receiving a tunnel setup request from the mobile station; and (2) in response to receiving the request, transmitting one or more local home agent addresses to the mobile station that are configured for use by the mobile station when accessing the one or more packet data services.

According to another aspect of the invention, a mobile station is provided that is capable of selecting a home agent in a visited network to use when accessing one or more packet data services. The mobile station may comprise a processor and a memory in communication with the processor and storing an application executable by the processor. In one exemplary embodiment, the application is capable, upon execution, of: (1) generating and transmitting a tunnel setup request; (2) receiving, in response to the tunnel setup request, one or more local home agent addresses; and (3) selecting one of the local home agent addresses received for use when accessing the one or more packet data services.

According to a final aspect of the present invention, a computer program product is provided for selecting a home agent in a visited network to use when accessing one or more packet data services. The computer program product contains at least one computer-readable storage medium having computer-readable program code portions stored therein. The computer-readable program code portions of one exemplary embodiment include: (1) a first executable portion for generating a tunnel setup request; (2) a second executable portion for transmitting the tunnel setup request; (3) a third executable portion for receiving, in response to the tunnel setup request, one or more local home agent addresses; and (4) a fourth executable portion for selecting one of the local home agent addresses received for use when accessing the one or more packet data services.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a typical, roaming WLAN IW Architecture for accessing CDMA2000 Packet Data Services;

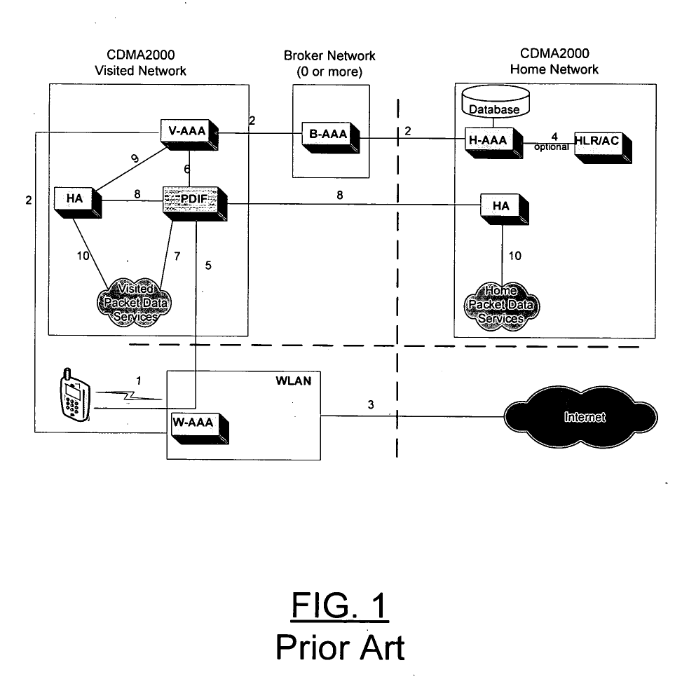

FIG. 2 is a signal flow diagram of the HA selection process according to one embodiment of the present invention;

FIG. 3 is a signal flow diagram of the HA selection processing according to another embodiment of the present invention;

FIG. 4 is a schematic block diagram of a mobile station capable of operating in accordance with an exemplary embodiment of the present invention; and

FIG. 5 is a schematic block diagram of an entity capable of operating as a tunnel termination endpoint and/or AAA server in accordance with exemplary embodiments of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention provide a method of enabling a mobile station (MS) to select which home agent (HA) in a visited network the MS will use when accessing packet data services, such as CDMA2000 Packet Data Services. In general, this process is done by pushing (using, for example, Internet Key Exchange version 2 (IKEv2), Dynamic Host Configuration Protocol (DHCP), or Extensible Authentication Protocol (EAP)) one or more local HA addresses to the MS by a tunnel termination endpoint (e.g., a PDIF) upon successful tunnel establishment between the MS and the tunnel termination endpoint. The MS can then select from those pushed HA addresses which one to use for accessing the packet data services. In other words, for example, once a MS has successfully established a secure tunnel between itself and a PDIF, the PDIF will push one or more local HA addresses to the MS, from which the MS can choose.

For exemplary purposes only, reference is made throughout to CDMA2000 Packet Data Services. As one of ordinary skill in the art will recognize, however, exemplary embodiments of the present invention are not limited to use when accessing packet data services of CDMA2000 and, in contrast, may be implemented with respect to accessing any packet data services.

Method of Enabling the Mobile Station to Select a Local Home Agent:

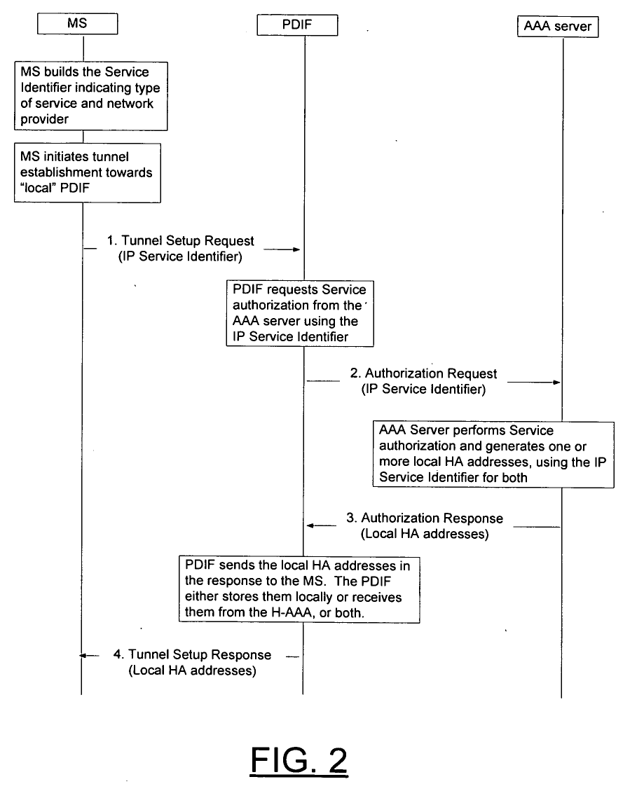

In one embodiment, illustrated by the signal flow diagram of FIG. 2, the method begins when the MS indicates during tunnel establishment that it requires a local HA. For example, the MS may indicate a desire for a local HA by building an IP Service Identifier (ISI), which indicates to the PDIF that the MS is attempting to access a local service and, therefore, that the PDIF can allocate a local HA and send an indication of the local HA to the MS. In particular, the ISI built by the MS may include some combination of (1) an indication of the service the MS is intending to use once the tunnel is established, (2) an indication of the network operator being used, whether home or visited, (3) an indication of the mobile station subscriber's service provider, (4) an indication of the location of the mobile station and (5) an indication of the location of the mobile station subscriber's service provider. The PDIF uses this information contained in the ISI to decide which local HA address(es) to send to the MS. In one embodiment, the ISI is transported to the PDIF in an IKE exchange. Alternatively, the ISI could be transported in, for example, an EAP, DHCP or a DNS (Domain Name System) exchange.

Once the ISI is built, the MS initiates tunnel establishment toward a “local” PDIF in Step 1 by sending a tunnel setup request including the ISI to the local PDIF. In one embodiment, this “local” PDIF is selected by the MS using a DNS procedure in conjunction with the ISI, as described in the '113 application, referenced above. In Step 2, the PDIF will request service authorization from the AAA server, such as the local or visited AAA server, using the ISI by sending an authorization request including the ISI to the AAA server. In Step 3, the AAA server first will use the ISI to perform service authorization and, if necessary, to generate one or more local HA addresses, and will then transmit an authorization response including any generated local HA addresses to the PDIF. The PDIF will then transmit this response, including the local HA addresses, to the MS in Step 4. This response may, for example, be transported in an IKE, EAP, DNS or DHCP exchange. The procedure is slightly different, however, depending upon which exchange is used. For example, where either IKE or EAP is used,. the request including the ISI and the reply containing the one or more local HA addresses can be done during tunnel setup as described above. By contrast, where DHCP is used, the DHCP request and reply must be done after the tunnel setup procedure has been completed. Where a DNS exchange is used, the local HA discovery can be done before, during or after the tunnel setup procedure.

As described above, the PDIF may retrieve the local HA addresses from the local or visited AAA server, for example, as part of the tunnel establishment authorization process. Alternatively, the H-AAA server may know the addresses of the local HAs. In these instances, the PDIF can, instead, retrieve the addresses from the H-AAA server. As yet another alternative, the PDIF may store the local HA addresses locally and therefore need not retrieve the local HA addresses from an AAA server. In the instance where the PDIF retrieves the local HA addresses from an AAA server, however, the AAA server first decides whether the user is allowed to use the visited service (PDIF). Only if the user is so allowed will the AAA server send the local HA addresses as part of the tunnel authorization process.

After receiving the local HA addresses, the MS will store these addresses for later use. When the MS initiates MIP (Mobile Internet Protocol) signaling, it will first decide whether it wants a local or a home HA. Where the MS wants a local HA, it will use the stored visited HA addresses. Otherwise, it will follow the normal procedures to discover a home HA, i.e., a HA in the home network of the MS.

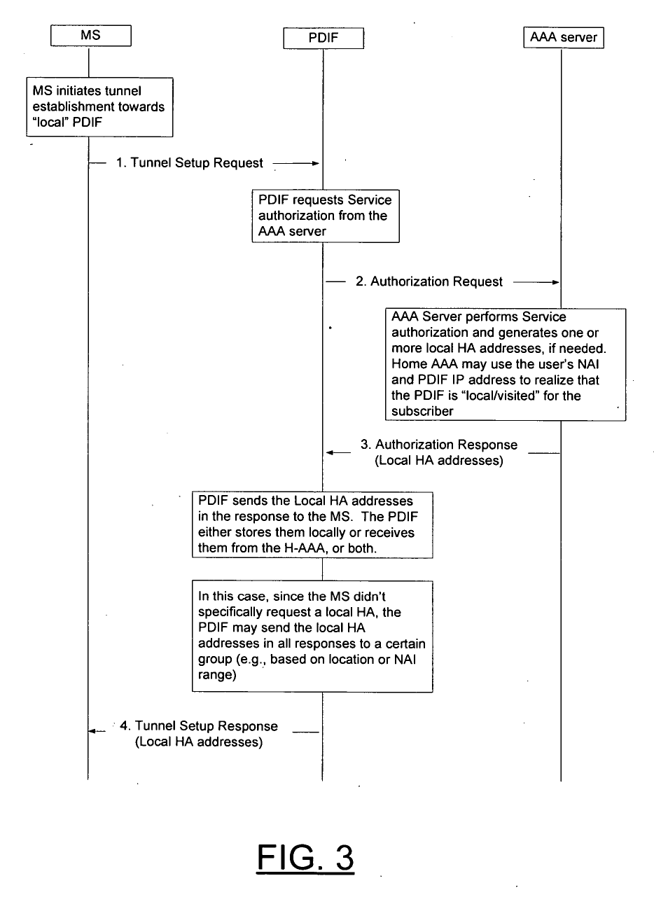

In another embodiment, illustrated by the signal flow diagram of FIG. 3, the MS does not indicate in the tunnel establishment request that it requires a specific HA. Rather, the PDIF automatically sends its local HA addresses either to all MSs that have successfully performed a tunnel establishment, or only to a certain group of subscribers, for example, those that are visiting. The PDIF knows that the user is a visiting subscriber based on the Network Access Identifier (NAI) included in the tunnel establishment request sent by the MS to the PDIF.

The method of this embodiment begins when the MS initiates tunnel establishment towards the “local” PDIF by sending a tunnel setup request (Step 1) (i.e., without first building an IP Service Identifier (ISI) and including the ISI in the tunnel setup request). In Step 2, the PDIF requests service authorization from the AAA server, such as the local or visited AAA server, by sending an authorization request. The AAA server then performs service authorization and generates one or more local HA addresses, if needed. Local HA addresses may be needed, as discussed above, either for all MSs who are successfully authenticated, or for only those that are visiting. The AAA server may use the user's NAI and/or the PDIF IP address to realize whether or not the user is a visiting subscriber and therefore requires one or more local HA addresses. In Step 3, the AAA server transmits the authorization response including the generated one or more local HA addresses, where applicable, to the PDIF. In Step 4, the PDIF sends the local HA addresses in a tunnel setup response to the MS. As described above, the PDIF may receive the local HA addresses from the local or visited AAA server. Alternatively, the H-AAA may know the addresses of the local HAs such that the PDIF can retrieve the addresses from the H-AAA server, instead of from the local or visited AAA server. Still further, the PDIF may instead store the local HA addresses locally, so as not to need to retrieve the local HA addresses from either the local/visited AAA server or the H-AAA server. Regardless of the origin of the local HA addresses, the MS will store these local HA addresses and will use them when it initiates MIP signaling and wants to use a local HA.

Mobile Station and Network Entity Architecture:

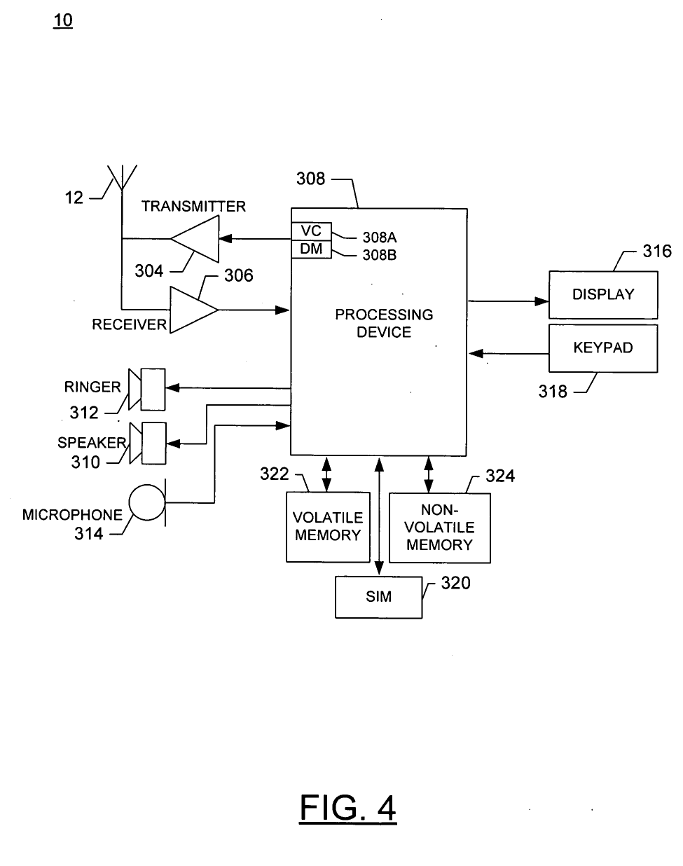

Reference is now made to FIG. 4, which is also shown and described in the '113 application that is incorporated herein, and which illustrates one type of mobile station 10 that would benefit from embodiments of the present invention. In particular, FIG. 4 illustrates a mobile device including various means for performing one or more functions in accordance with exemplary embodiments of the present invention. It should be understood, however, that the mobile device illustrated and hereinafter described is merely illustrative of one type of mobile device or station that would benefit from the present invention and, therefore, should not be taken to limit the scope of the present invention. Other types of mobile devices, such as personal digital assistants (PDAs), laptop computers, as well as other types of electronic devices including both mobile, wireless devices and fixed, wireline devices, can readily employ embodiments of the present invention.

As stated above, the mobile device includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 4, in addition to an antenna 12, the mobile device 10 includes a transmitter 304, a receiver 306, and means, such as a processing device 308, e.g., a processor, controller or the like, that provides signals to and receives signals from the transmitter 304 and receiver 306, respectively. These signals include signaling information in accordance with the air interface standard of the applicable cellular system and also user speech and/or user generated data. In this regard, the mobile device can be capable of operating with one or more air interface standards, communication protocols, modulation types, and access types. More particularly, the mobile device can be capable of operating in accordance with any of a number of second-generation (2G), 2.5G and/or third-generation (3G) communication protocols or the like. Further, for example, the electronic device can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the electronic device and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. The processing device can additionally include an internal voice coder (VC) 308A, and may include an internal data modem (DM) 308B. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile device may also comprise means such as a user interface including, for example, a conventional earphone or speaker 310, a ringer 312, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile device and may include a full set of alphanumeric keys or set of keys that may be activated to provide a full set of alphanumeric keys. Although not shown, the mobile device may include a battery, such as a vibrating battery pack, for powering the various circuits that are required to operate the electronic device, as well as optionally providing mechanical vibration as a detectable output.

The mobile device can also include means, such as memory including, for example, a subscriber identity module (SIM) 320, a removable user identity module (R-UIM) (not shown), or the like, which typically stores information elements related to a mobile subscriber. In addition to the SIM, the electronic device can include other memory. In this regard, the electronic device can include volatile memory 322, as well as other non-volatile memory 324, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IME1) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for generating and transmitting a tunnel setup request, receiving, in response, one or more local home agent addresses, and selecting one of the local home agent addresses received for use when accessing one or more packet data services. The memory may further store computer program code for building an IP Service Identifier including some combination of a preferred service, a network operator and a service provider, and including the IP Service Identifier in the generated and transmitted tunnel setup request.

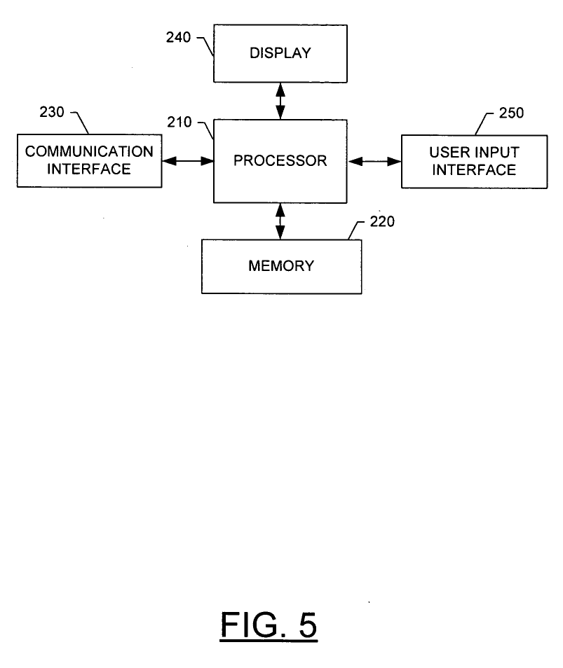

Referring now to FIG. 5, a block diagram of an entity capable of operating as a tunnel termination endpoint (e.g., a PDIF) and/or an AAA server (e.g., home or visited) is shown in accordance with one embodiment of the present invention. The entity capable of operating as a tunnel termination endpoint and/or AAA server includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a tunnel termination endpoint and/or AAA server can generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device.

Conclusion:

As described above and as will be appreciated by one skilled in the art, embodiments of the present invention may be configured as a system, method, mobile device or network entity. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. For example, although certain embodiments of the present invention were described in conjunction with CDMA2000 networks, the system and method of the present invention may also have application to other types of networks. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of enabling a mobile station to select a home agent in a visited network to use when accessing one or more packet data services, said method comprising:
transmitting a tunnel setup request;
receiving, in response to the tunnel setup request, one or more local home agent addresses; and
selecting one of the local home agent addresses received for use when accessing the one or more packet data services.

2. The method of claim 1, wherein the tunnel setup request comprises a request for authorization to access the one or more packet data services and a request for generation of one or more local home agent addresses.

3. The method of claim 1 further comprising:
building an IP Service Identifier comprising a combination of one or more of a preferred service, a network operator, a service provider, a location of the mobile station, and a location of the service provider, wherein transmitting a tunnel setup request comprises transmitting a request comprising the IP Service Identifier, such that the IP Service Identifier is capable of being used to generate the one or more local home agent addresses.

4. The method of claim 1, wherein transmitting a tunnel setup request comprises transmitting the request to a tunnel termination endpoint.

5. The method of claim 4, wherein the one or more local home agent addresses are generated based at least in part on a Network Access Identifier associated with the mobile station and an IP address associated with the tunnel establishment endpoint.

6. The method of claim 1, further comprising:
storing the one or more local home agent addresses received.

7. A system for enabling a mobile station to select a home agent in a visited network to use when accessing one or more packet data services, said system comprising:
a mobile station configured to generate and transmit a tunnel setup request; and
a tunnel termination endpoint in communication with the mobile station, the tunnel termination endpoint configured to receive the request and, in response to receiving the request, to transmit one or more local home agent addresses, such that the mobile station is capable of selecting one of the local home agent addresses for use when accessing the one or more packet data services.

8. The system of claim 7, wherein the mobile station is further configured to generate an IP Service Identifier comprising a combination of one or more of a preferred service, a network operator, a service provider, a location of the mobile station, and a location of the service provider and to include the IP Service Identifier in the tunnel setup request.

9. The system of claim 8 further comprising:
a memory accessible by the tunnel termination endpoint and comprising a plurality of local home agent addresses, wherein the tunnel termination endpoint is further configured to access the memory and to select a respective one or more home agent addresses to transmit to said mobile station based at least in part on the IP Service Identifier.

10. The system of claim 8, wherein the tunnel termination endpoint is further configured to generate and transmit a service authorization request comprising the IP Service Identifier, and wherein the system further comprises:
an Authentication, Authorization and Accounting (AAA) server in communication with the tunnel termination endpoint, the AAA server configured to receive the service authorization request and, in response to receiving the service authorization request, to generate, based at least in part on the IP Service Identifier, the one or more local home agent addresses and to transmit the one or more local home agent addresses to the tunnel termination endpoint for transmitting to the mobile station.

11. The system of claim 10, wherein the AAA server comprises a Visited-AAA server.

12. The system of claim 7 further comprising:
a Home Authentication, Authorization and Accounting (H-AAA) server in communication with the tunnel termination endpoint, wherein the tunnel termination endpoint is further configured to request the one or more local home agent addresses from the H-AAA, and wherein the H-AAA is configured to generate and transmit the local home agent addresses to the tunnel termination endpoint for transmitting to the mobile station.

13. The system of claim 7, wherein the one or more local home agent addresses transmitted to the mobile station are automatically generated based at least in part on a Network Access Identifier associated with the mobile station and an IP address associated with the tunnel termination endpoint.

14. A network entity capable of enabling a mobile station to select from one or more home agents in a visited network to use when accessing one or more packet data services, said network entity comprising:
a processor; and
a memory in communication with the processor, the memory storing an application executable by the processor, wherein the application is capable, upon execution, of receiving a tunnel setup request from the mobile station, and, in response to receiving the request, transmitting one or more local home agent addresses to the mobile station that are configured for use by the mobile station when accessing the one or more packet data services.

15. The network entity of claim 14, wherein the memory further stores a plurality of home agent addresses, and wherein the application is further capable, upon execution, of accessing the plurality of home agent addresses and of selecting a respective one or more home agent addresses to transmit to the mobile station.

16. The network entity of claim 15, wherein the tunnel setup request received comprises an IP Service Identifier comprising a combination of one or more of a preferred service, a network operator, a service provider, a location of the mobile station, and a location of the service provider, and wherein said application is further capable, upon execution, of evaluating the IP Service Identifier and of selecting a respective one or more local home agent addresses to transmit based at least in part on the IP Service Identifier.

17. The network of claim 15, wherein selecting a respective one or more local home agent addresses to transmit to the mobile station comprises selecting based at least in part on a Network Access Identifier associated with the mobile station and an IP address associated with the network entity.

18. The network entity of claim 14, wherein the application is further capable, upon execution, of generating and transmitting a service authorization request based at least in part on the tunnel setup request and, in response to the service authorization request, of receiving the one or more local home agent addresses to transmit to the mobile station.

19. The network entity of claim 14, wherein the tunnel setup request comprises an IP Service Identifier comprising a combination of one or more of a preferred service, a network operator, a service provider, a location of the mobile station, and a location of the service provider, and wherein generating and transmitting a service authorization request comprises generating and transmitting a request comprising the IP Service Identifier.

20. A mobile station capable of selecting a home agent in a visited network to use when accessing one or more packet data services, said mobile station comprising:
a processor; and
a memory in communication with the processor, the memory storing an application executable by the processor, wherein the application is capable, upon execution, of:
generating and transmitting a tunnel setup request;
receiving, in response to the tunnel setup request, one or more local home agent addresses; and
selecting one of the local home agent addresses received for use when accessing the one or more packet data services.

21. The mobile station of claim 20, wherein the application is further capable, upon execution, of building an IP Service Identifier comprising a combination of one or more of a preferred service, a network operator, a service provider, a location of the mobile station, and a location of the service provider, and transmitting the IP Service Identifier as part of the tunnel setup request, such that the IP Service Identifier is capable of being used to generate the one or more local home agent addresses.

22. The mobile station of claim 20, wherein transmitting a tunnel setup request comprises transmitting the request to a tunnel termination endpoint.

23. The mobile station of claim 22, wherein the one or more local home agent addresses are generated based at least in part on a Network Access Identifier associated with the mobile station and an IP address associated with the tunnel termination endpoint.

24. The mobile station of claim 20, wherein the application is further capable, upon execution, of storing the one or more local home agent addresses received in the memory.

25. A computer program product for selecting a home agent in a visited network to use when accessing one or more packet data services, wherein the computer program product comprises at least one computer-readable storage medium having computer-readable program code portions stored therein, the computer-readable program code portions comprising:
a first executable portion for generating a tunnel setup request;
a second executable portion for transmitting the tunnel setup request;
a third executable portion for receiving, in response to the tunnel setup request, one or more local home agent addresses; and
a fourth executable portion for selecting one of the local home agent addresses received for use when accessing the one or more packet data services.

26. The computer program product of claim 25, wherein generating a tunnel setup request comprises building an IP Service Identifier comprising a combination of one or more of a preferred service, a network operator, a service provider, a location of the mobile station, and a location of the service provider, and wherein transmitting the tunnel setup request comprises transmitting the request and the IP Service Identifier, such that the IP Service Identifier is capable of being used to generate the one or more local home agent addresses.

27. The computer program product of claim 25, wherein transmitting a tunnel setup request comprises transmitting the request to a tunnel termination endpoint.

28. The computer program product of claim 27, wherein the one or more local home agent addresses are generated based at least in part on a Network Access Identifier associated with the mobile station and an IP address associated with the tunnel termination endpoint.

29. The computer program product of claim 25 further comprising:
a fifth executable portion for storing the one or more local home agent addresses received.
